(19) United States
(12) Patent Application Publication
(10) Pub. No.: US 2001/0009639 A1
(43) Pub. Date: Jul. 26, 2001

(54) Storage

(76) Inventor: Peter George Gunn, Walsall (GB)

Correspondence Address: SMITH-HILL AND BEDELL, 12670 N W BARNES ROAD, SUITE 104, PORTLAND, OR, 97229

(21) Appl. No.: 09/809,777

(22) Filed: Mar. 16, 2001

Related U.S. Application Data
(63) Continuation of application No. 09/225,995, filed on Jan. 5, 1999, now abandoned.

(30) Foreign Application Priority Data
Jan. 7, 1998 (GB) 9800173.8

(51) Int. Cl. B65G 1/00

(52) U.S. Cl. 414/286

(57) ABSTRACT

A pallet 10 for use with a racking system has an upper surface 12 and engagement means in the form of hooks 14 and a rear rim 16 which will engage a racking system. A continuous base 18 is spaced below the upper surface 12, in use. This allows the pallet to sit flat on a roller conveyor system, for instance. Apertures 20 allow fork lift tines to be introduced and are provided on each of the four sides of the pallet 10, for ease of handling. Structures within the pallet add to safety by ensuring that the pallet is restrained against sliding or tipping on the fork lift tines.

A pallet racking system is also described, having box section vertical members capable of acting as structural members, e.g. to support a mezzanine floor.

The present invention relates to storage, and in particular to palletised storage of goods, for instance in a warehouse.

Warehouse storage systems have been proposed in which a racking system is provided, on which pallets may be stored. In view of the many possible uses of warehouse storage space, it is desirable for the pallet and racking system design to provide as much versatility as possible.

The present invention provides a pallet for storage on a racking system, the pallet comprising an upper surface on which a load is supported, in use, engagement means which, in use, engage the racking system to secure the pallet thereto, a base spaced below the upper surface, in use, and apertures located between the upper surface and the base, and into which the tines of a fork lift may be introduced, wherein the base is substantially continuous over the lowermost face of the pallet.

Preferably apertures are provided to receive tines, selectively, from at least two directions. The two directions are preferably perpendicular. The pallet is preferably generally square or rectangular, the two directions being perpendicular to sides of the pallet. Preferably, apertures are provided to allow tines to enter and support the pallet from any of the four sides of the pallet.

Retaining means may be provided within the pallet, to engage tines to retain the pallet and tines substantially in a predetermined relative orientation during use. The retaining means may comprise sleeve members within the pallet, the apertures opening into the sleeve members to allow the tines to mate therewith when introduced into the apertures. The sleeve members may define sleeves which extend across substantially the whole extent of the pallet. At least some of the sleeves are preferably wholly enclosed. The sleeve members may provide reinforcement to the strength of the pallet, thereby increasing the load carrying capacity over that of a pallet without the sleeve members.

Preferably the pallet comprises no downward projections beyond the base, whereby the pallet may rest on a flat surface with the base in contact therewith.

The pallet may comprise a metal upper surface and a metal base, and is preferably substantially wholly of metal components.

The invention also provides a pallet for storage on a racking system, the pallet comprising an upper surface on which a load is supported, in use, engagement means which, in use, engage the racking system to secure the pallet thereto, a base spaced below the upper surface, in use, and apertures located between the upper surface and the base, and into which the tines of a fork lift may be introduced, wherein apertures are provided to receive tines, selectively, in at least two directions.

In another aspect, the invention provides a pallet for storage on a racking system, the pallet comprising an upper surface on which a load is supported, in use, engagement means which, in use, engage the racking system to secure the pallet thereto, a base spaced below the upper surface, in use, and apertures located between the upper surface and the base, and into which the tines of a fork lift may be introduced, wherein retaining means are provided within the pallet to engage tines to retain the pallet and tines substantially in a predetermined relative orientation during use.

Pallets according to the second and third aspects of the invention may incorporate any or all of the features set out above in relation to the first aspect, in any desired combination.

According to a further aspect of the invention, there is provided a pallet racking system comprising at least one load-bearing upright member which is of hollow section.

Preferably the said upright members is of box section and may be used as a service conduit. Preferably the upright member is sufficiently strong to form a structured component of the building in which the system is installed, such as to provide support for a mezzanine floor. The hollow section of the upright member preferably acts as a service conduit to supply the mezzanine floor.

Preferably the racking system comprises at least four upright members. Each upright member is preferably of hollow section as aforesaid. The upright members may be arranged in a square or rectangular arrangement in plan, and adapted to support a square or rectangular pallet at or near respective corners thereof.

The pallet racking system according to this aspect of the invention may further comprise a plurality of pallets according to any of the first three aspects of the invention.

Embodiments of the present invention will now be described in more detail, by way of example only, and with reference to the accompanying drawings, in which:

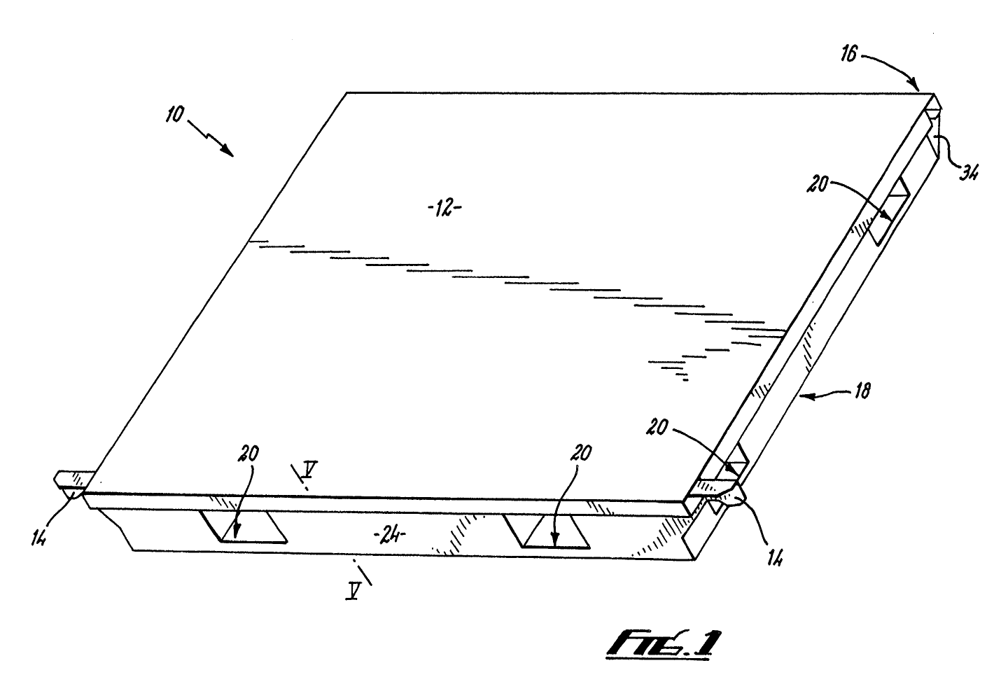

FIG. 1 is a perspective view from above, of a pallet according to the present invention;

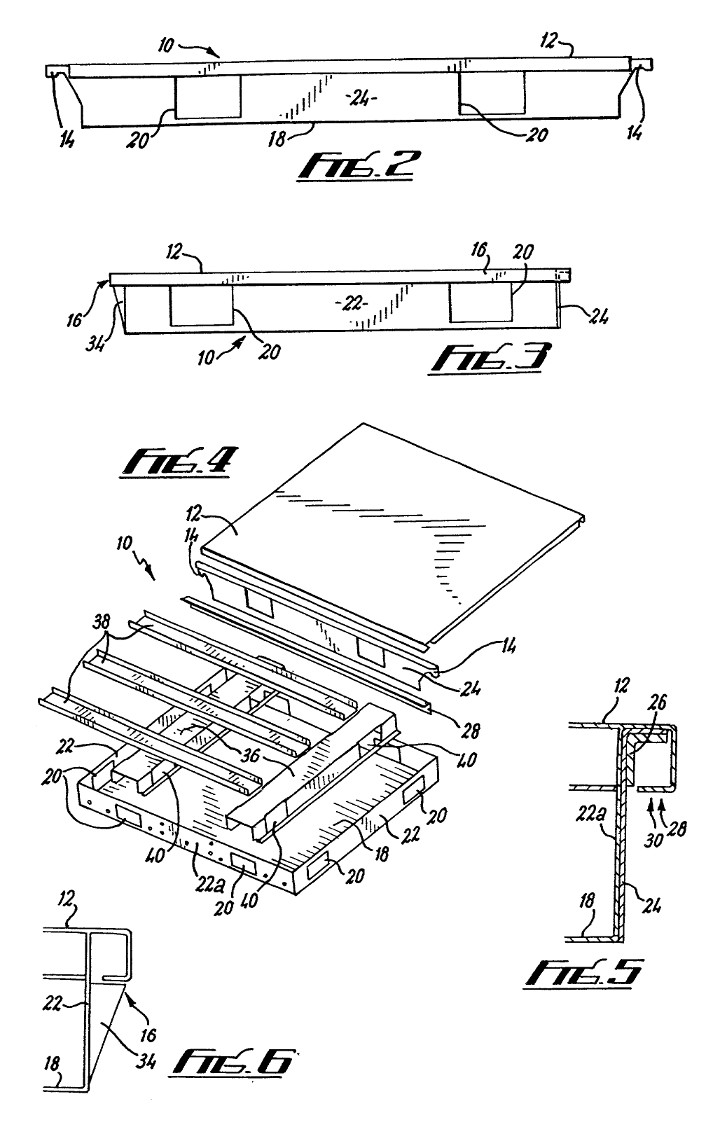

FIGS. 2 and 3 are front and side elevations of the pallet of FIG. 1;

FIG. 4 is an exploded perspective view of the pallet of FIG. 1, viewed from the rear;

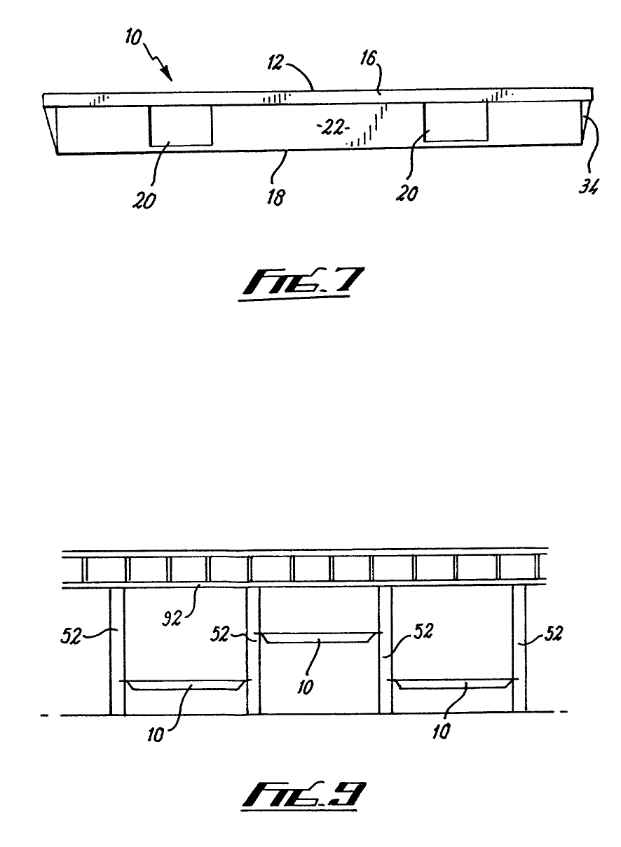

FIG. 5 is a partial vertical section along the line V-V of FIG. 1;

FIG. 6 is a partial side elevation looking in the same direction as FIG. 5;

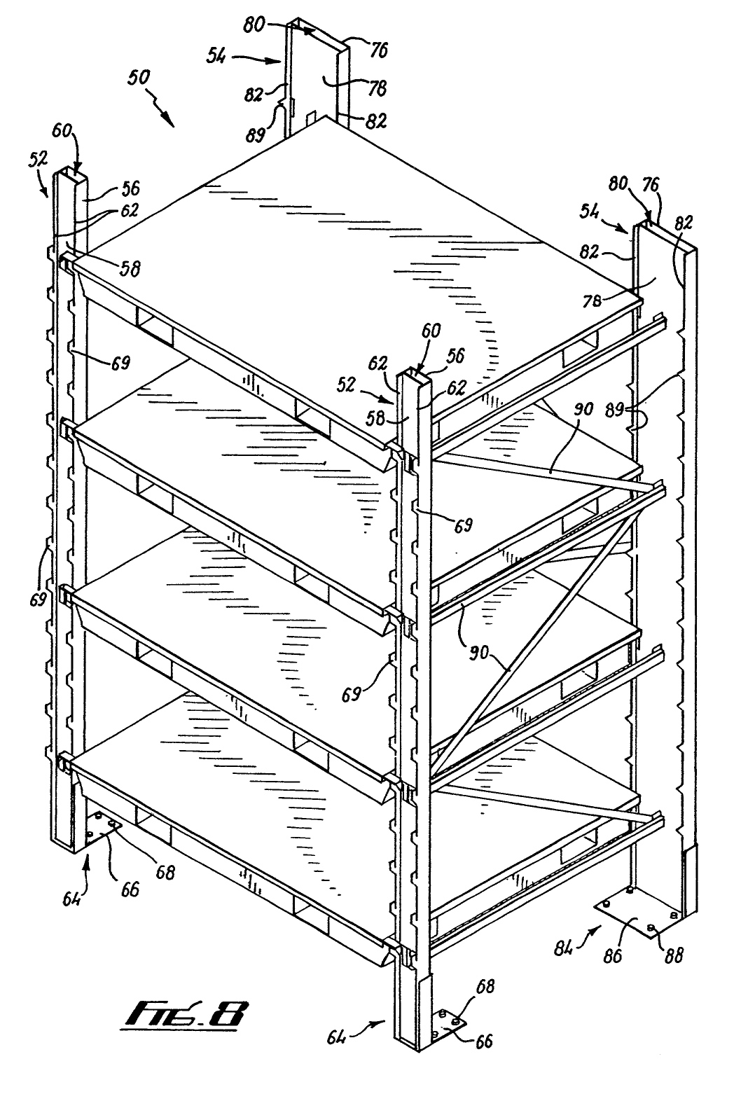

FIG. 7 is a rear elevation of the pallet of FIG. 1;

FIG. 8 is a perspective view of a pallet rack and pallets; and

FIG. 9 is a simplified elevation of the pallet rack of FIG. 8 acting as a structural component of a building.

FIGS. 1 to 7 of the drawings show a pallet 10 for storage on a racking system (not shown). The pallet comprises an upper surface 12 on which a load is supported, in use. Engagement means in the form of hooks 14 and a rear rim 16 will engage a racking system, in use, to secure the pallet 10 to the system. The pallet 10 also has a base 18 spaced below the upper surface 12, in use. Apertures 20 are located between the upper surface 12 and the base 18. The tines of a fork lift may be introduced into the apertures 20, as will be described.

It can be seen from these drawings (particularly FIG. 4) that the base 18 is substantially continuous over the lowermost face of the pallet 10. Apertures 20 are provided on each of the four sides of the pallet 10, so that tines may be introduced into the pallet from each of four directions, selectively. The structures within the pallet 10, to be described below, add to safety by ensuring that the pallet is restrained against sliding or tipping on tines, even if the load on the pallet 10 moves.

In more detail, the pallet 10 has a base 18 formed of sheet metal and carrying upstanding walls 22 in a rectangular or square arrangement. Each wall 22 has two apertures 20 formed at a separation corresponding to the standard separation of fork lift tines. The size of the apertures 20 is large enough to allow a tine to be readily introduced.

The base 18 and walls 22 form, in effect, a box which is closed by the surface 12, which is another sheet metal component forming a lid on the box.

Other components are positioned between the lid 12 and base 18, as follows.

A face plate 24 extends across the full width of the pallet 10, adjacent the front wall 22a, and is welded thereto. The face plate 24 extends beyond the wall 22a, providing two hook projections 14 for use in hooking onto cooperating formations on a racking system. Additional strength along this edge is provided by an angle bar 26 which extends along the top edge of the face plate 24 and is secured thereto, such as by welding. These features are best seen in FIG. 5, which also illustrates an overhand 30 provided along the front edge of the lid 12, again for added strength. Similar overhands are provided along substantially the whole of each edge of the lid 12. The overhang 16 along the back edge of the pallet 10 provides a further engagement for cooperating formations on a racking system. For instance, a racking system could be provided with hooks to engage at two or more positions along the rear overhang 16, and projections over which the hooks 14 can hook to support the front of the pallet 10, so that the pallet 10 and its load are then supported along the front and back of the pallet 10.

In view of this function of the overhang 16, it may be further strengthened by webs 34 at appropriate positions along its length.

Two sleeve members 36 are provided within the box. These are inverted channel section members having a cross-section to receive a tine, and being welded to the base 18 in alignment with apertures 20, so that a tine can be introduced into either socket in the front or back of the pallet 10, to move through the apertures 20 and mate with the sleeve 36. When a tine is received in the sleeve 36, the pallet 10 will be held in position relative to it, so that the pallet cannot tip off the tines, twist or otherwise move relative to the tines; the sleeves 36 only allow tines to penetrate the pallet or be withdrawn.

The sleeves 36 perform this function in relation to tines introduced from the front or back of the pallet 10. A similar function is provided in relation to the transverse directions by means of channel members 38. These lie along the base 18, preferably being welded thereto, in alignment with apertures 20 in the two sides of the pallet 10. Where they intersect with the sleeves 36, the sleeves have openings 40 to receive the channel members 38. Consequently, a tine introduced through an aperture 20 in a side wall of the pallet 10 can move in to mate with the channel member 38, also passing through the openings 40 as the tine penetrates further into the pallet 10 and thereafter being retained by interaction with the channel members 38 and sleeves 36 to hold the pallet 10 in a substantially fixed orientation relative to the tines, as described above.

The presence of the sleeves 36 and channel members 38 will prevent the pallet tipping when on fork lift tines and thus enhances safety even if the load on the pallet is uneven, or shifts as the pallet is moved. The sleeves 36 and channel members 38 also provide additional structural strength to the arrangement by forming a lattice of reinforcement, which thus provides an increased load carrying capacity for the pallet over that which would be obtained in the absence of the sleeves and channel members.

The flatness of the base 18, and the absence of any projections below that, ensure that the base 18 forms the lowermost face of the pallet 10 and thus that the pallet may rest on a flat surface with the base in contact with the surface. Thus, the pallet can safely and securely be rested on a surface such as that of a conveyor system, or stacked on another like pallet. In addition, the flat base 18 allows the pallet to sit flat on a roller conveyor system without needing any other intermediary such as a wooden slave pallet underneath.

When on a conveyor system, the provision for lifting from any of the four sides of the pallet 10 allows the pallet to be subsequently handled from either side of the conveyor system, or from an end of the conveyor, without requiring turntables or other handling systems to turn the pallet.

Turning now to FIG. 8, there is shown a racking system 50 on which pallets 10 are supported. Four pallets are shown in FIG. 8. The system 50 comprises two front uprights 52 and two rear uprights 54. The front uprights each comprise a square U-shaped channel member 56 closed by a web 58 to form a hollow box section at 60. The web 58 is within the mouth of the channel member 56, leaving projecting flanges 62.

The front uprights 52 are installed in an upright orientation by securing arrangements at 64, including securing plates 66 and ground bolts 68. The flanges 62 are each formed to provide a column of hooks 69 for supporting pallets 10, as will be described. Each upright 52 provides two columns of hooks 69, one for each of two neighbouring bays, only one storage bay being shown in FIG. 8.

The rear uprights 54 each comprise a square U-shaped channel member 76 closed by a web 78 to form a hollow box section at 80. The web 78 is within the mouth of the channel member 76, leaving projecting flanges 82.

The rear uprights 54 are installed in an upright orientation by securing arrangements at 84, including securing plates 86 and ground bolts 88. The flanges 82 are each formed to provide a column of teeth 89 for supporting pallets 10, as will be described. Each upright 54 provides two columns of teeth 99, one for each of the two neighbouring bays, as discussed above.

Horizontal and diagonal braces 90 may be provided between the uprights 52,54, as required.

It can be seen from FIG. 8 that pallets 10 as described in relation to FIGS. 1 to 7 can be supported on the racking system 50 by locating the overhand 16 at the rear of the pallet 10 on two horizontally aligned teeth 89 on rear uprights 54, and then lowering the hooks 14 into engagement with hooks 69 on the front uprights 52, thus providing support for the pallet 10 at or near each of its four corners. It will be evident from FIG. 8 that the columns of hooks 69 and teeth 89 provide significant versatility, allowing the pallets 10 to be supported at a variety of heights on the racking system 50. Thus, if a pallet contains a relatively tall or shallow load, the pallet above can be moved up or down to minimise wasted space and thereby improve the overall efficiency of the storage system.

The hollow sections provided in the uprights 52,54 can be used as service conduits in the building in which the system 50 is installed. For instance, service pipes or cables can run up through the sections 60,80. Thus, any of the four legs of a bay can be used to protect a run of electrical cables (for power supply, computer or other equipment purposes) or pipes (for water or chemical supply, fire sprinklers or other purposes). These services will be well protected against damage and fire by virtue of their containment within the box sections 60,80 and by virtue of the strength of the uprights 52,54, because the uprights 52,54 will normally be manufactured of metal.

In particular, it is envisaged that the uprights 52,54 will be manufactured of steel of substantial gauge. In one example, a steel thickness of 3 mm can be used, with the box section 60 of the front uprights 52 having dimensions of approximately 88 mm×35 mm, and the box section 80 of the rear uprights 54 having dimensions of approximately 238 mm×38 mm. With these dimensions, the racking system 50 is expected to be able to bear loads up to 35 to 40 tons. This gives the arrangement adequate strength to provide a further advantage, as illustrated schematically in FIG. 9. This illustrates a line of uprights 52 forming a series of storage bays within a warehouse, and supporting at the upper ends a mezzanine floor 92, for instance allowing office accommodation to the provided above the storage area. The mezzanine floor 92 can be provided with services such as power, water, heat, computer services, fire protection and the like, by services running in the box sections 60,80.

The strength of the box section uprights 52,54 also provides high resistance against side impacts, such as may occur through careless use of fork trucks, thus preventing damage.

In a further modification, it is envisaged that the racking system 50 may be sufficiently structurally strong to be used as framework for exterior cladding to enclose the building, that is, the racking section 50 would form a structural part of the building.

It will be apparent to the skilled man that many variations and modifications can be made to the apparatus described above, without departing from the scope of the present invention. Although the pallet is preferably made substantially wholly of metal in the interests of strength and durability, some or all components could alternatively be manufactured of other materials for particular applications. Hooks and a rim have been described for engagement with the racking system described, but other formations could be built in to the design according to the nature of the racking system with which the pallet is to be used. The pallet has been described as being rectangular or square, as is conventional, but other shapes could be used. Handling the pallet has been described in relation to fork lifts and their tines, but other handling apparatus using lifting forks could alternatively be used with the pallet. Many of these systems use forks of the same size and separation as conventional fork lift tines, to allow interchangeability, but it will be apparent that the apertures 20 can be separated and sized according to the shape and separation of the lifting forks with which the pallets are intended to be used. Various modifications in the shape, size, form and materials of the uprights can be envisaged.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A pallet for storage on a racking system, the pallet comprising an upper surface on which a load is supported, in use, engagement means which, in use, engage the racking system to secure the pallet thereto, a base spaced below the upper surface, in use, and apertures located between the upper surface and the base, and into which the tines of a fork lift may be introduced, wherein the base is substantially continuous over the lowermost face of the pallet.

2. A pallet according to claim 1, wherein apertures are provided to receive tines, selectively, from at least two directions.

3. A pallet according to claim 2, wherein the two directions are perpendicular.

4. A pallet according to claim 3, wherein the pallet is generally square or rectangular, the two directions being perpendicular to sides of the pallet.

5. A pallet according to claim 4, wherein apertures are provided to allow tines to enter and support the pallet from any of the four sides of the pallet.

6. A pallet according to claim 1, wherein retaining means are provided within the pallet, to engage tines to retain the pallet and tines substantially in a predetermined relative orientation during use.

7. A pallet according to claim 6, wherein the retaining means comprise sleeve members within the pallet, the apertures opening into the sleeve members to allow the tines to mate therewith when introduced into the apertures.

8. A pallet according to claim 7, wherein the sleeve members define sleeves which extend across substantially the whole extent of the pallet.

9. A pallet according to claim 7, wherein at least some of the sleeves are wholly enclosed.

10. A pallet according to claim 7, wherein the sleeve members provide reinforcement to the strength of the pallet, thereby increasing the load carrying capacity over that of a pallet without the sleeve members.

11. A pallet according to claim 1, wherein the pallet comprises no downward projections beyond the base, whereby the pallet may rest on a flat surface with the base in contact therewith.

12. A pallet according to claim 1, wherein the pallet comprises a metal upper surface and a metal base.

13. A pallet according to claim 1, wherein the pallet is made substantially wholly of metal components.

14. A pallet for storage on a racking system, the pallet comprising an upper surface on which a load is supported, in use, engagement means which, in use, engage the racking system to secure the pallet thereto, a base spaced below the upper surface, in use, and apertures located between the upper surface and the base, and into which the tines of a fork lift may be introduced, wherein apertures are provided to receive tines, selectively, in at least two directions.

15. A pallet according to claim 14 and claim 1.

16. A pallet for storage on a racking system, the pallet comprising an upper surface on which a load is supported, in use, engagement means which, in use, engage the racking system to secure the pallet thereto, a base spaced below the upper surface, in use, and apertures located between the upper surface and the base, and into which the tines of a fork lift may be introduced, wherein retaining means are provided within the pallet to engage tines to retain the pallet and tines substantially in a predetermined relative orientation during use.

17. A pallet according to claim 16 and claim 1.

18. A pallet racking system comprising at least one load-bearing upright member which is of hollow section.

19. A system according to claim 18, wherein the said upright member is of box section to serve as a service conduit.

20. A system according to claim 18, wherein the upright member is sufficiently strong to form a structural component of the building in which the system is installed.

21. A system according to claim 20, wherein the upright member provides support for a mezzanine floor.

22. A system according to claim 20, wherein the upright member has a hollow section which acts as a service conduit to supply the mezzanine floor.

23. A system according to claim 18, wherein the racking system comprises at least four upright members.

24. A system according to claim 23, wherein each upright member is of hollow section.

25. A system according to claim 23, wherein the upright members are arranged in a square or rectangular arrangement in plan, and are adapted to support a square or rectangular pallet at or near respective corners thereof.

26. A pallet racking system according to claim 18, further comprising a plurality of pallets according to claim 1.
